(19) United States
(12) Patent Application Publication
(10) Pub. No.: US 2008/0103216 A1
(43) Pub. Date: May 1, 2008

(54) Dispersion method, redispersion method and crush method of dispersoids, and apparatuses therefor

(76) Inventors: Yasuo Nakatsuka, Osaka (JP); Susumu Kiyohara, Osaka (JP); Michio Tan, Osaka (JP); Kenichi Ikeda, Osaka (JP); Katsufumi Tanaka, Kyoto-shi (JP); Ryuichi Akiyama, Kyoto-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/812,326

(22) Filed: Jun. 18, 2007

(30) Foreign Application Priority Data
Jun. 22, 2006 (JP) 172642/2006

(51) Int. Cl. B01F 3/12

(52) U.S. Cl. 516/33; 422/243

(57) ABSTRACT

The present invention provides a method for uniformly dispersing dispersoids in a dispersion medium. The method of the present invention for dispersing dispersoids includes applying an electric field to a mixture of a dispersion medium and dispersoids. In this dispersion method, a dispersion apparatus containing a container 3 for placing a mixture 2 of a dispersion medium and dispersoids, and an electric field application means 4 for applying an electric field to the mixture 2, which has a pair of opposing electrodes 5a and 5b, can be used.

### TECHNICAL FIELD OF THE INVENTION

The present invention relates to a method of dispersing or redispersing dispersoids in a dispersion medium and a method of crushing aggregated dispersoids, and apparatuses used for these methods.

### BACKGROUND OF THE INVENTION

Composite materials wherein an organic or inorganic filler as a dispersoid is dispersed in an organic resin as a dispersion medium have been used in diversified fields. Such composite materials are generally prepared by subjecting a mixture of a dispersion medium and dispersoids to a dispersion treatment using a dispersion apparatus such as a ball mill and the like (JP-A-2004-27206). The principle of the dispersion method is dispersion by application of mechanical impact, vibration, shearing force and the like to dispersoids from the outside. However, dispersoids such as inorganic filler and the like easily aggregate due to the van der Waals force and electrostatic force between dispersoids, or humidity, solvents to be used for preparation and the like. During a dispersion treatment of the mixture or after the dispersion treatment, therefore, dispersoids may be aggregated, or a dispersoid having a higher density than that of the dispersion medium tends to precipitate and cause inconsistent density and the like. By the above-mentioned dispersion method, therefore, a composite material wherein dispersoids are uniformly dispersed in a dispersion medium cannot be obtained easily.

To solve such problem, a dispersing agent or a surfactant may be added to the aforementioned mixture during a dispersion treatment. In general, however, once a dispersing agent or a surfactant is adsorbed on the surface of a dispersoid, the functions inherent to the dispersoid such as conductivity, thermal conductivity, photorefractive property and the like tend to be easily degraded. In view of the above, it is considered desirable to not add a dispersing agent and a surfactant when a good dispersion state can be achieved. When a dispersing agent or a surfactant is added, a hydrophobic group or a hydrophilic group is formed on the surface of the dispersoid, which in turn considered to improve dispersibility since an interparticle repulsive force (repulsion) is imparted to the dispersoid. Since the amount of the dispersoids to be added is limited depending on the volume occupied by the hydrophobic group and hydrophilic group, a desired amount of dispersoids may not be added in some cases.

Accordingly, construction of a convenient method capable of eliminating or preventing aggregation and precipitation of dispersoids, and uniformly dispersing dispersoids in a dispersion medium has been desired.

### SUMMARY OF THE INVENTION

### Disclosure of the Invention

### [Problems to be Solved by the Invention]

The present invention has been made in view of such situation and aims at providing a method of uniformly dispersing dispersoids in a dispersion medium, a method of crushing or redispersing dispersoids aggregated or precipitated in a dispersion medium, and apparatuses usable for these methods.

### [Means of Solving the Problems]

The present inventors have conducted intensive studies in an attempt to solve the aforementioned problems and found that elimination and prevention of aggregation and precipitation of dispersoids is possible by applying an electric field to a mixture of a dispersion medium and dispersoids, and moreover, that dispersoids can be dispersed as particles fine to the extent possible in a dispersion medium, which resulted in the completion of the present invention.

Accordingly, the present invention provides the following.

(1) A method of uniformly dispersing dispersoids in a dispersion medium, which comprises applying an electric field to a mixture of the dispersion medium and the dispersoids.

(2) A method of uniformly redispersing dispersoids in a dispersion medium, which comprises applying an electric field to a mixture of the dispersion medium and the dispersoids precipitated therein.

(3) A method of crushing aggregated dispersoids, which comprises applying an electric field to a mixture of the aggregated dispersoids and the dispersion medium.

(4) The method of any one of the above-mentioned (1)-(3), wherein the dispersion medium is a solvent or an organic resin, which is a liquid or has flowability at the temperature during application of the electric field.

(5) The method of any one of the above-mentioned (1)-(4), wherein the dielectric constant of the dispersoid is higher than that of the dispersion medium.

(6) The method of any one of the above-mentioned (1)-(5), wherein the dispersoid is at least one kind from an inorganic particle and an inorganic fiber.

(7) The method of any one of the above-mentioned (1)-(6), wherein an alternating voltage is applied as the electric field.

(8) The method of any one of the above-mentioned (1)-(7), wherein the electric field is applied between parallel electrodes.

(9) A composition obtained by the method of any one of the above-mentioned (1)-(3).

(10) A dispersion apparatus for dispersoids, comprising a container for placing a mixture of a dispersion medium and dispersoids, and an electric field application means having a pair of opposing electrodes, which is used for applying an electric field to the mixture.

(11) An apparatus for redispersing or crushing dispersoids, comprising a container for placing a mixture of a dispersion medium and aggregated or precipitated dispersoids, and an electric field application means having a pair of opposing electrodes, which is used for applying an electric field to the mixture.

(12) The apparatus of the above-mentioned (10) or (11), further comprising, in the container, a stirring means for agitating the mixture.

(13) The apparatus of any one of the above-mentioned (10)-(12), further comprising a feeding means for feeding the mixture to the electric field application means.

(14) The apparatus of any one of the above-mentioned (10)-(13), further comprising a crude dispersion means for roughly dispersing the dispersoids in the mixture.

(15) The apparatus of any one of the above-mentioned (10)-(14), wherein the waveform of a power source of the electric field is an alternating current.

(16) The apparatus of any one of the above-mentioned (10)-(15), wherein the electrode comprises parallel electrodes.

### [Effect of the Invention]

According to the dispersion method of the present invention, when an electric field is applied to a mixture of a dispersion medium and dispersoids, an electric charge or dielectric polarization occurs in the dispersoids, which in turn develops interparticle repulsion on the dispersoids themselves. Consequently, the dispersoids in the dispersion medium can be crushed into finer particles than before the application of the electric field and uniformly dispersed therein. While the present inventors are not certain as to the cause of such effect, they assume that at least one of the following factors 1)-4) induces repulsion (e.g., interparticle repulsion) on the dispersoids themselves due to the application of an electric field.

1) A local and instantaneous explosion or swelling phenomenon occurs in the interface between particles (dispersoids, hereinafter the same) and the liquid phase (dispersion medium, hereinafter the same), and the energy thereof separates the particle interface.

2) The aggregated secondary particles vibrate as a whole due to the vibration energy, and the vibration causes a frictional force in the particle interface.

3) Since the electric field application conditions produce massive electric field strength for the particles, dielectric polarization generally occurs. Depending on the material of the particles (e.g., ferroelectric materials such as barium titanate and the like), the polarization reversal occurs, which changes the crystal structure of the particles, generating a crystal lattice distortion of about 1%.

4) The particles themselves are charged.

The technical significance of the dispersion method of the present invention is high because dispersoids can be uniformly dispersed and crushed utilizing a convenient means including application of an electric field, based on the principle different from that of conventional methods.

According to the present invention, moreover, dispersoids can be uniformly redispersed in a dispersion medium by the application of an electric field to a mixture of the precipitated dispersoids and the dispersion medium, and the aggregated dispersoids can be crushed by the application of an electric field to a mixture of the dispersion medium and the aggregated dispersoids, based on the same principle as mentioned above.

According to the present invention, furthermore, a dispersoid dispersion apparatus, a dispersoid redispersion apparatus and a crush dispersoid apparatus applicable to the above-mentioned method can also be provided.

### BRIEF DESCRIPTION OF THE DRAWINGS

FIG. 1 is a schematic diagram showing one embodiment of the dispersion apparatus of the present invention.

FIG. 2 is a schematic diagram showing another embodiment of the dispersion apparatus of the present invention.

FIG. 3 is a schematic diagram showing another embodiment of the dispersion apparatus of the present invention.

FIG. 4 is a schematic diagram showing another embodiment of the dispersion apparatus of the present invention.

FIG. 5 shows SEM photographs of the mixtures obtained in Examples 2-4 and Comparative Examples 2-4.

### EXPLANATION OF SYMBOLS

1A: dispersion apparatus, 2: mixture, 3: container, 4: electric field application means, 5: electrode, 6: amplifying device, 7: voltage generator

### DETAILED DESCRIPTION OF THE INVENTION

### Best Mode for Embodying the Invention

The present invention is explained in detail in the following by referring to preferable embodiments thereof. In the explanation of the drawings, the same element is accorded with the same symbol and duplicate explanations are omitted. For the convenience of showing, the size ratio of the drawings is not necessarily the same as that in the explanation.

The dispersion apparatus of the present invention is first explained.

### FIRST EMBODIMENT

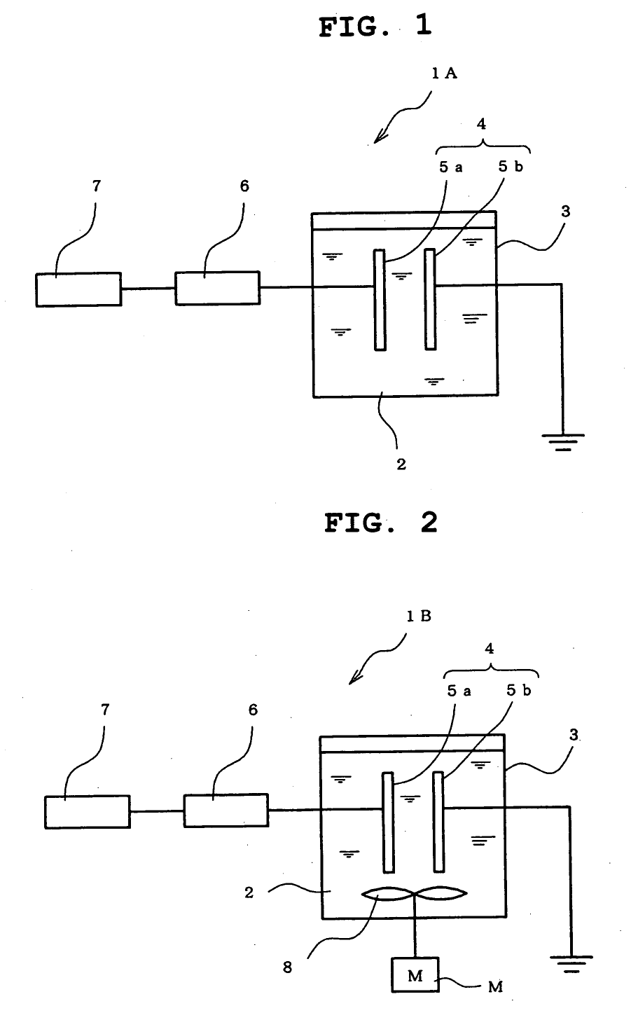

FIG. 1 is a schematic diagram showing the constitution of the dispersion apparatus of the first embodiment of the present invention.

A dispersion apparatus 1A uniformly disperses dispersoids in a dispersion medium, and a batch treatment method is employed. The dispersion apparatus 1A has a container 3 for placing a mixture 2, and an electric field application means 4 for applying an electric field to the mixture 2. The electric field application means 4 has a pair of opposing electrodes (5a, 5b), and the electrodes are connected to an amplifying device 6 and a voltage generator 7 that permit application of an electric field under desired conditions. When the melting point or softening point of the dispersion medium to be used is not less than room temperature, a heating means may be set in the container 3 so that the dispersion medium will have flowability during application of an electric field.

The mixture 2 includes a dispersion medium and dispersoids. The dispersion medium is the largest component in the mixture and forms a continuous phase. On the other hand, the dispersoids consist of ultrafine particles dispersed in a dispersion medium, which are easily aggregated due to the van der Waals force and electrostatic force between dispersoids, or humidity, solvents to be used for preparation and the like. The mixture 2 may be prepared by separately feeding a dispersion medium and dispersoids in the container 3, or a mixture 2 prepared in advance may be used. When the mixture 2 is prepared in advance, a known dispersion apparatus such as a dispersion impeller, a ball mill, a bead mill, a ultrasonic dispersion apparatus and the like may be used to perform a crude dispersion treatment. As a result, the efficiency of the dispersion treatment by the application of an electric field can be enhanced and the dispersibility of the dispersoids can be further improved.

The container is not particularly limited as long as the inner wall of the container is insulation-treated. For example, a stainless container with a lining of alumina or zirconia on the inner wall can be used. For electrode, for example, metal materials (e.g., stainless) coated with oxide ceramics (e.g., ITO, ATO, antimony oxide) having conductivity, which are not easily metal-ionized in an electric field treatment liquid, can be used. As the electrode, a plate electrode is preferably used since a uniform electric field can be obtained, and its shape is rectangle, circular shape and the like. In addition, the electrode may be mobile so that the distance between electrodes can be controlled. As a result, the optimal electric field strength can be set with ease.

Using the dispersion apparatus of this embodiment, an electric field can be applied under optimal treatment conditions to the dispersoids to be used. Therefore, a mixture wherein dispersoids are uniformly dispersed in a dispersion medium can be conveniently obtained.

### SECOND EMBODIMENT

FIG. 2 is a schematic diagram showing the constitution of the dispersion apparatus in the second embodiment of the present invention.

A dispersion apparatus 1B has a container 3, an electric field application means 4, an amplifying device 6 and a voltage generator 7, as well as a stirring means 8 for agitating a mixture 2 in the container 3. The stirring means 8 in this embodiment is an impeller set on the bottom surface of the container 3 and connected to a motor M. However, the stirring means 8 is not limited and, for example, a magnetic stirrer, an ultrasonic transducer, a thermal convection and the like can also be used. In this embodiment, such stirring means diffuses mixture 2 in the whole container 3. Thus, precipitation of dispersoids can be prevented, and a treated liquid present between electrodes can be substituted to an untreated liquid. As a result, an electric field can be uniformly applied to the mixture 2 kept in the container 3. Thus, a mixture wherein dispersoids are more uniformly dispersed in a dispersion medium can be obtained. The constitution and configuration of the container 3, electric field application means 4, amplifying device 6 and voltage generator 7 in the dispersion apparatus 1B are as explained for the first embodiment.

### THIRD EMBODIMENT

FIG. 3 is a schematic diagram showing the constitution of the dispersion apparatus in the third embodiment of the present invention.

A dispersion apparatus 1C has a container 3, an electric field application means 4, an amplifying device 6, a voltage generator 7 and a stirring means 8, as well as a feeding means 9 for feeding a mixture 2 to the electric field application means 4. The feeding means 9 is connected to pump P for efficiently feeding the mixture 2 to an electric field application means 4. As a result, the yield is improved because the mixture 2 circulates in the system, which enables continuous dispersion treatment. Moreover, the feeding means 9 is connected to a discharge means 10 to discharge a treated mixture. Accordingly, a treated mixture can be taken through the discharge means 10 for confirmation of the dispersion state, based on which whether or not the mixture should be circulated and dispersed can be determined. The constitution and configuration of the container 3, electric field application means 4, amplifying device 6, voltage generator 7 and stirring means 8 in the dispersion apparatus 1C are as explained for the first embodiment.

### FOURTH EMBODIMENT

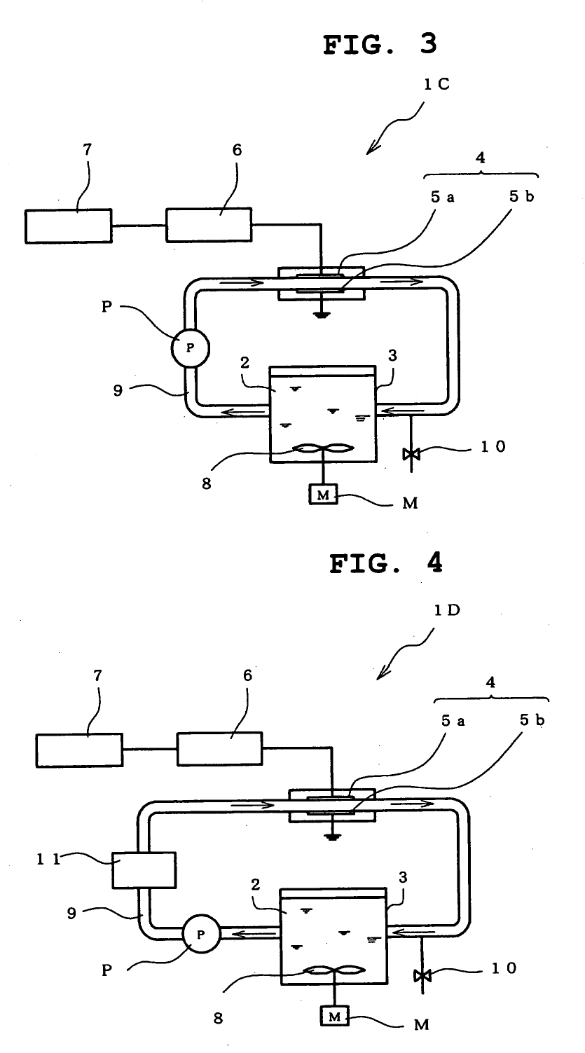

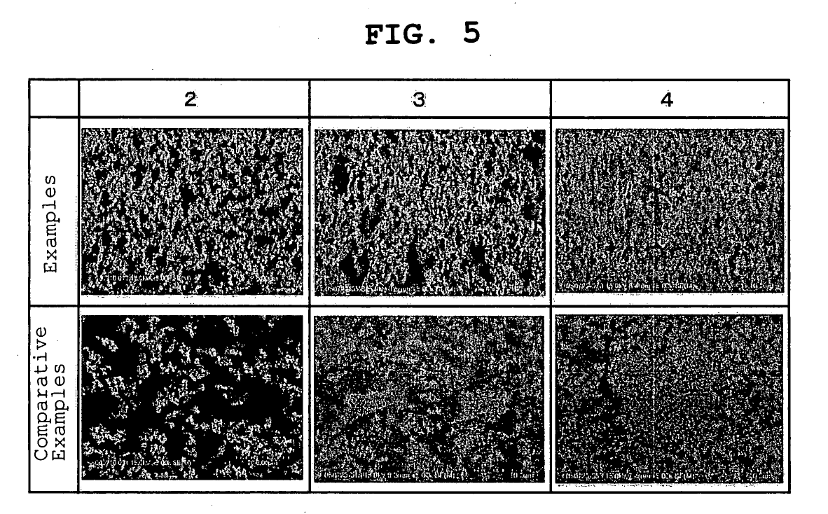

FIG. 4 is a schematic diagram showing the constitution of the dispersion apparatus in the fourth embodiment of the present invention.

A dispersion apparatus 1D is connected to a container 3, an electric field application means 4, an amplifying device 6, a voltage generator 7, a stirring means 8 and a feeding means 9, as well as a crude dispersion means 11 for roughly dispersing dispersoids in the mixture 2. By this constitution, an electric field treatment can be continuously applied to a mixture that underwent a preliminary dispersion treatment. As a result, the treatment efficiency can be improved still further and the dispersibility of the dispersoids in a dispersion medium can also be improved further. As the crude dispersion means 11, any dispersion apparatus known in the pertinent field can be used and, for example, a dispersion impeller, a ball mill, a bead mill or an ultrasonic dispersion apparatus can be used. The constitution and configuration of the container 3, electric field application means 4, amplifying device 6, voltage generator 7, stirring means 8, feeding means 9 and discharge means 10 in the dispersion apparatus 1D are as explained for the first to third embodiments.

While the dispersion apparatus of the present invention has been explained in detail in the above, the aforementioned dispersion apparatus can be used as the redispersion apparatus and crushing apparatus of the present invention. In this case, using a mixture of a dispersion medium and dispersoids precipitated therein for a redispersion apparatus, precipitation of the dispersoids is eliminated and a mixture wherein the dispersoids having a smaller particle size than before the application of the electric field are uniformly dispersed in the dispersion medium can be obtained. Moreover, using a mixture of a dispersion medium and dispersoids aggregated therein for a crushing apparatus, the coagulation force of dispersoids is weakened. As a result, a mixture wherein the dispersoids having a smaller particle size than before the application of the electric field is uniformly dispersed in the dispersion medium can be obtained.

Now, the method of the present invention for dispersing dispersoids is explained by referring to the aforementioned dispersion apparatus of the present invention.

First, a mixture of a dispersion medium and dispersoids is placed in a container in a dispersion apparatus. As mentioned above, a dispersion medium and dispersoids may be separately fed in the container to prepare a mixture, or a mixture prepared in advance may be used. When a mixture is prepared in advance, a crude dispersion treatment may be applied using a known dispersion apparatus such as a dispersion impeller, a ball mill, a bead mill, an ultrasonic dispersion apparatus and the like.

As the dispersion medium, a medium which is a liquid or has flowability at a temperature of an electric field treatment, which has viscosity to permit dispersoids to move in the dispersion medium, is preferably used. That is, when the dispersoid content is low, the dispersoids can be moved by the application of an electric field even when the dispersion medium has a relatively high viscosity. When the dispersoid content is high, however, the dispersoids cannot be moved easily unless the viscosity of the dispersion medium is set to a relatively low level. Thus, the viscosity of the dispersion medium and the content of the dispersoid are desirably adjusted so that the dispersoids can move easily in the dispersion medium when an electric field is applied.

As the dispersion medium, for example, a solvent or an organic resin is preferably used.

As the solvent, for example, hydrocarbons (e.g., hexane, toluene), ethers (tetrahydrofuran (THF)), esters (e.g., ethyl acetate, butyl acetate), ketones (e.g., methylethylketone (MEK), acetone), amides (e.g., N-methyl-2-pyrrolidone (NMP), N,N-dimethylformamide (DMF), N-dimethylacetamide (DMAC)) or alcohols (methanol, ethanol, isopropyl alcohol (IPA)) can be used. Of these, an aprotic polar solvent is preferably used and, specifically, MEK, acetone, NMP or ethyl acetate is preferably used. They can be used alone or two or more kinds thereof can be used in combination.

As the organic resin, for example, thermoplastic resin, thermosetting resin, photocurable resin, electron beam (EB) curable resin and the like are preferably used. They can be used alone or two or more kinds thereof can be used in combination. As the thermoplastic resin, one having a melting point or softening point lower than the temperature during application of an electric field is preferably used. As the thermosetting resin or photocurable resin, one that is liquid or has flowability at room temperature is preferably used. While the viscosity of the organic resin varies depending on the property (e.g., content, particle size, shape, surface roughness (surface friction resistance)) of the dispersoid, conditions of electric field application (e.g., frequency of electric field, strength of electric field, application time, temperature) and the like, for example, the viscosity at 25° C. is generally 10-2,000 mPa•S, preferably 10-200 mPa•S. Here, the viscosity is measured using a B type viscosimeter according to JIS 7117-1.

Specifically, as the thermoplastic resin, polyimide resin, polyamide resin, polyamideimide resin, polyphenyleneoxide, polyphenylenesulfone and the like can be preferably used, with more preference given to polyimide resin. In addition, as the thermosetting resin, epoxy resin, phenol resin, silicone resin, unsaturated polyester resin, bismaleid resin, cyanate resin and the like can be preferably used. Of these, epoxy resin is more preferable, and for example, a liquid epoxy resin obtained by mixing an aliphatic epoxy resin such as aliphatic polyglycidyl ether and the like as the base resin, and a curing agent (e.g., acid anhydride) and a curing accelerator (e.g., tertiary amine, Lewis acid base type catalyst) is preferably used. The mixing ratio of respective components can be appropriately determined according to the object. As the photocurable resin, ultraviolet (UV)-curable resin and the like can be used. As the photo or electron beam curable resin, for example, a liquid curable resin made of a mixture of an oligomer such as epoxyacrylate, urethane acrylate and the like, a reactive diluent and a photopolymerization initiator (e.g., benzoin, acetophenone etc.) is preferably used. The mixing ratio of respective components can also be determined appropriately according to the object.

As the dispersoid, for example, inorganic particles and inorganic fiber such as ceramics, metal, alloy and the like, and organic resin particles can be used. As the shape of the dispersoid, for example, sphere, ellipse, needle, plate, fiber and the like can be mentioned, with preference given to sphere and fiber. The dispersoid preferably has a dielectric constant higher than that of the dispersion medium and, for example, inorganic particles, inorganic fiber and the like are preferably used. They can be used alone or two or more kinds thereof are used in combination.

As the inorganic particles, for example, metal or non-metal carbide, nitride, oxide and the like can be used. Specifically, inorganic powders such as silicon carbide, silicon nitride, boron nitride, aluminum oxide, barium titanate, tin oxide, tin-antimony oxide, titanium oxide/tin-antimony oxide, indium-tin oxide and the like can be used. As the inorganic fiber, for example, ceramics fiber such as barium titanate, alumina, silica, carbon and the like, metal fiber such as iron, copper and the like can be used, with preference given to ceramics fiber such as barium titanate and the like. As the organic resin particles, for example, a powder of polyolefin resin such as polyethylene, polypropylene, polymethylpentene and the like, acrylic resin, polystyrene resin, fluorine resin, silicone resin or a mixture thereof and the like can be used. For example, acrylic resin particles (e.g., crosslinked acrylic particles, non-crosslinked acrylic particles) are commercially available as MX series, MR series and MP series (all of which are trade names of SOKEN CHEMICAL & ENGINEERING CO., LTD.), and polystyrene resin particles (e.g., crosslinked polystyrene particles) are commercially available as SX series and SGP series.

As the dispersoid, for example, a particle having a two-layer structure (particle with core/shell two-layer structure) wherein a metal particle is used as a core and its outer surface is coated with an inorganic oxide may be used. Specifically, a particle having a two-layer structure wherein a copper particle is used as a core and its outer surface is coated with barium titanate can be used. Moreover, dispersoids having different shapes can be used in combination. For example, an inorganic fiber having a diameter of an nm size such as carbon nanotube and a spherical inorganic particle can be used in combination.

As the dispersoid, one having an about uniform particle size and without dispersion in the particle size distribution is preferably used. The average particle size of the dispersoid is generally 0.5 nm-100 μm, preferably 10 nm-20 μm, more preferably 100 nm-10 μm. When the particle size is less than 0.5 nm, the response to the electric field tends to be degraded due to the Brownian motion of the dispersoid. On the other hand, when it exceeds 100 μm, the dispersoid tends to precipitate due to the gravity. In the present specification, the average particle size means an average particle size (D50) obtained by measuring the dispersoids to be used with a laser diffraction particle size distribution measurement apparatus (type SALD-2100, manufactured by Shimadzu Corporation). When the average particle size is 0.1 μm or below, it means an average particle size (D50) obtained by measuring with a dynamic light scattering particle size distribution analyzer (type N5, manufactured by Beckman Coulter, Inc.). For an inorganic fiber, the average particle size means a value obtained by measuring the fiber assumed to have a spherical shape.

The content of dispersoids can be appropriately determined according to the object of use of the mixture. It is generally 1-60% by volume, preferably 5-30% by volume, more preferably 10-20% by volume, relative to the dispersion medium. The aforementioned range is desirable because when the content of the dispersoids is high, the dispersoids cannot move easily when a electric field is applied.

Then, an electric field is applied to the mixture.

When the dispersion medium constituting the mixture is a liquid, or has flowability at room temperature, an electric field is directly applied. When the dispersion medium is not a liquid and does not have flowability at room temperature, an electric field is applied with heating to impart flowability to the dispersion medium.

While a direct voltage or an alternating voltage can be applied as the electric field in the present invention, an alternating voltage is preferable from the aspect of dispersion effect. The treatment conditions for alternating voltage are as follows.

The electric field strength is generally 0.1-50 kV/mm, preferably 1-25 kV/mm, more preferably 5-20 kV/mm. When it is less than 0.1 kV/mm, the aggregate does not respond to the electric field easily. When it exceeds 50 kV/mm, the mixture tends to show a dielectric breakdown.

The frequency is generally 0.1-1 MHz, preferably 0.1-100 kHz, more preferably 0.1-50 kHz, still more preferably 0.1-20 kHz. When the frequency is outside the above-mentioned range, a desired dispersion state cannot be obtained easily.

While the treatment time is not the same for the various dispersion media to be used, it is generally 0.01-100 min, preferably 0.5-30 min, more preferably 1-10 min. When it is less than 0.01 min, the dispersoids are sometimes not sufficiently dispersed and, when it exceeds 100 min, the mixture tends to show a dielectric breakdown.

The alternating voltage is particularly preferably applied under the conditions shown in Table 1 in consideration of the average particle size of the dispersoids, the dielectric constants of the dispersoids and organic resin and the like.

TABLE 1

| | ratio (A/B) of | | |
|---|---|---|---|
| average | dielectric constant | | |
| particle | (A) of dispersoid | | |
| size (μm) | and dielectric | electric field | |
| of | constant (B) of | strength | frequency |
| dispersoid | organic resin | (kV/mm) | (kHz) |
| ≧1 | ≧10 | ≧0.1 | ≧0.1 |
| | | (preferably | |
| | | 0.1-10) | |
| | <10 | ≧1 | ≧0.1 |
| | | (preferably | |
| | | 1-20) | |
| <1 | ≧10 | ≧1 | ≧0.1 |
| | | (preferably | |
| | | 1-50) | |
| | <10 | ≧10 | ≧0.1 |
| | | (preferably | |
| | | 10-50) | |

In the present invention, by application of an electric field under the above-mentioned conditions, the dispersoids in the dispersion medium can be crushed into finer particles than before the application of the electric field and uniformly dispersed therein.

While the cause of such effect has not been elucidated, the present inventors assume that at least one of the following factors 1)-4) imparts repulsion (e.g., interparticle repulsion) to the dispersoids themselves upon application of an electric field, and therefore, aggregation of dispersoids due to the van der Waals force of the dispersoids can be suppressed, thereby affording the above-mentioned effect.

1) A local and instantaneous explosion or swelling phenomenon occurs in the interface between particles (dispersoids, hereinafter the same) and the liquid phase (dispersion medium, hereinafter the same), and the energy thereof separates the particle interface.

2) The aggregated secondary particles vibrate as a whole due to the vibration energy, and the vibration causes a frictional force in the particle interface.

3) Since the electric field application conditions produce massive electric field strength for the particles, dielectric polarization generally occurs. Depending on the material of the particles (e.g., ferroelectric materials such as barium titanate and the like), the polarization reversal occurs, which changes the crystal structure of the particles, generating a crystal lattice distortion of about 1%.

4) The particles themselves are charged.

On the other hand, the principle of the conventional dispersion method using a ball mill and the like is dispersion by application of mechanical impact, vibration, shearing force and the like to dispersoids from the outside, and therefore, the dispersion principle is completely different from that of the present invention. In addition, the conventional dispersion methods fail to easily disperse dispersoids in a dispersion medium with good reproducibility, and are associated with a limitation on the production of an ultrafine dispersoid.

The dispersion method of the present invention can, based on the aforementioned dispersion principle, uniformly disperse dispersoids in a dispersion medium as particles ultrafine to the extent possible. Hence, a composition obtainable by this method is useful as a composition for at least one of the following electric or electronic components 1)-4).

1) electric or electronic components requested to have high dielectricity, such as printed circuit board, capacitor and the like

2) electric or electronic components requested to have high thermal conductivity, such as printed circuit board, semiconductor sealing resin package and the like

3) anisotropic conductive sheet used for electrically connecting a function element (e.g., IC and the like) and an electronic part (e.g., printed circuit board and the like) in a particularly ultrafine manner at multipoints at the same time

4) electric or electronic components requested to shield against an electromagnetic wave, such as printed circuit board, semiconductor sealing resin package etc., or these electronic device modules.

While the dispersion method of the present invention has been explained in detail in the above, the redispersion method and the crushing method of the present invention can redisperse or crush dispersoids based on the same principle as in the aforementioned dispersion method. That is, according to the redispersion method of the present invention, repulsion is induced on dispersoids by applying an electric field in the same manner as above to a mixture of a dispersion medium and dispersoids precipitated therein, and the precipitated dispersoids can be uniformly dispersed in the dispersion medium as finer particles than before the application of the electric field. According to the redispersion method of the present invention, moreover, repulsion is induced on dispersoids by applying an electric field in the same manner as above to a mixture of a dispersion medium and dispersoids aggregated therein, and the aggregated dispersoids can be crushed into finer particles than before the application of the electric field.

The present invention is explained in more detail in the following by referring to Examples, which are not to be construed as limitative.

### EXAMPLES

### Examples 1-4

Non-solvent type epoxy resin compositions were prepared by adding each component described in the following Table 2. The dielectric constant of the obtained non-solvent type epoxy resin compositions was 3.3.

TABLE 2

| | | Model | | Amount |
|---|---|---|---|---|
| | Distributor | number | Classification | added |
| base resin | Tohto kasei | ZX-1658 | Aliphatic | 100 parts |
| | Co., Ltd. | | | by weight |
| curing | Japan Epoxy | YH306 | acid | 160 parts |
| agent | Resins Co., | | anhydride | by weight |
| | Ltd. | | | |
| curing | PTI Japan Ltd. | K-61B | tertiary | 3 parts by |
| accelerator | | | amine, | weight |
| | | | Lewis base | |
| | | | type catalyst | |

To each of the obtained non-solvent type epoxy resin compositions was added barium titanate (BaTiO₃) (5, 10, 20 or 30 vol %, model number BT-03, manufactured by Sakai Chemical Industry Co., Ltd., average particle size 0.3 μm, purity not less than 99.9%, dielectric constant about 3,300) to give mixtures. The obtained mixtures were roughly dispersed using a planetary ball mill (model number Planet-M, manufactured by Gokin Planetaring). The container and ball used for the crude dispersion treatment were made of zirconia, and balls having a diameter of 1, 2, 4 or 8 mm were used in combination. The treatment conditions of the crude dispersion were number of revolution 600 rpm, number of rotation 1,500 rpm and treatment time 10 min.

Then, an electric field was applied to the obtained mixtures using an electric field treatment apparatus prepared by modifying a dynamic viscoelastic measurement apparatus (model MR-300V, manufactured by Rheology Co., Ltd.). As an upper electrode (1 oz copper foil) and a lower electrode (3 oz copper foil), copper foils were attached to SUS supports via a conductive two-sided tape. Thereafter, the mixture was injected between the electrodes and the gap amount was adjusted to 50-100 μm thick. The electric field application conditions were as shown in Table 3, and the treatment time was 5 min. The SUS supports were taken out from the electric field treatment apparatus. The conductive two-sided tapes were separated from the copper foils to give samples for the following evaluation.

TABLE 3

| | | electric field treatment conditions | | |
|---|---|---|---|---|
| | BaTiO₃ | waveform of | | electric field |
| | content | power source | frequency | strength |
| Example 1 | 5 vol % | alternating | 10 kHz | 16 kV/mm |
| | | current | | |
| Example 2 | 10 vol % | alternating | 10 kHz | 16 kV/mm |
| | | current | | |
| Example 3 | 20 vol % | alternating | 10 kHz | 16 kV/mm |
| | | current | | |
| Example 4 | 30 vol % | alternating | 10 kHz | 16 kV/mm |
| | | current | | |

### Examples 5-8

Carbon black (5 parts by weight, model number SB-4, manufactured by Degussa, average particle size 398 nm) and polyvinylpyrrolidone (PVP) dispersing agent (1 part by weight, model number K-90, manufactured by ISP Japan Ltd.) were added to N-methyl-2-pyrrolidone (NMP) (100 parts by weight) and the mixture was roughly dispersed with a dispersion impeller (rpm number 1200 rpm) for 20 min. After standing the mixture still for 30 min, the supernatant solution from the upper end of the container to the half thereof in the height direction was collected to give a mixture for evaluation.

Then, glass substrates having an ITO film (film thickness 200-300 Å) sputtered on the entire surface of one side were set as plate electrodes and the distance between the electrodes was set to 50 μm. A polyimide film with a thickness of 50 μm was used as a spacer, the mixture was filled between the electrodes using an Ar gas, and an electric field was applied to the mixture for 5 min under the electric field application conditions shown in Table 4. After the application of the electric field, NMP was injected between the electrodes and the mixture was taken out.

TABLE 4

electric field treatment conditions

| | waveform of | | electric field |
|---|---|---|---|
| | power source | frequency | strength |
| Example 5 | alternating | 5 kHz | 16 kV/mm |
| | current | | |
| Example 6 | alternating | 1 kHz | 16 kV/mm |
| | current | | |
| Example 7 | alternating | 0.5 kHz | 16 kV/mm |
| | current | | |
| Example 8 | alternating | 0.1 kHz | 16 kV/mm |
| | current | | |

### Examples 9-12

A mixture for evaluation was obtained in the same manner as in Example 5 except that carbon nanotube (model number MWCNT-2, multi-layer CNT, manufactured by Shenzhen Nanotech Port Co., Ltd., average tube diameter 20 nm, 0.5 part by weight) was used instead of the carbon black, and an electric field was applied to the mixture for 5 min under the electric field treatment conditions shown in Table 5.

TABLE 5

electric field treatment conditions

| | waveform of | | electric field |
|---|---|---|---|
| | power source | frequency | strength |
| Example 9 | alternating | 5 kHz | 16 kV/mm |
| | current | | |
| Example 10 | alternating | 1 kHz | 16 kV/mm |
| | current | | |
| Example 11 | alternating | 0.5 kHz | 16 kV/mm |
| | current | | |
| Example 12 | alternating | 0.1 kHz | 16 kV/mm |
| | current | | |

### Examples 13-17

Methylethylketone (MEK) solvent type epoxy resin compositions were prepared by adding each component described in the following Table 6. The dielectric constant of the obtained solvent type epoxy resin compositions was 3.3.

TABLE 6

| | | Model | | Amount |
|---|---|---|---|---|
| | Distributor | number | Classification | added |
| base resin | Dainippon Ink | HP-7200 | dicyclopenadiene | 100 |
| | And Chemicals, | | type | parts by |
| | Incorporated | | | weight |
| curing | Mitsui | XL-225L | paraxylene bond | 68 parts |
| agent | Chemicals, | | | by |
| | Inc. | | | weight |

| | | | |
|---|---|---|---|
| curing | Wako Pure | TPP (triphenylphosphine) | 0.5 part |
| accelerator | Chemical | | by |
| | Industries, | | weight |
| | Ltd. | | |

To the obtained solvent type epoxy resin compositions were added BaTiO₃ (model number BT-03, manufactured by Sakai Chemical Industry Co., Ltd., average particle size 0.3 μm, purity not less than 99.9%, dielectric constant about 3,300, 10 vol %) and the mixtures were dispersed with a dispersion impeller (number of rotation 1000 rpm) for 20 min. After standing the mixtures still for 30 min, the supernatant solutions from the upper end of the container to the half thereof in the height direction were collected to give dispersions for evaluation.

Then, glass substrates having an ITO film (film thickness 200-300 Å) sputtered on the entire surface of one side were set as plate electrodes and the distance between the electrodes was set to 50 μn. A polyimide film with a thickness of 50 μm was used as a spacer, the dispersion was filled between the electrodes using an Ar gas, and an electric field was applied to the dispersion for 10 min under the electric field application conditions shown in Table 7. After the application of the electric field, MEK was injected between the electrodes and the dispersion was taken out.

TABLE 7

electric field treatment conditions

| | waveform of | | electric field |
|---|---|---|---|
| | power source | frequency | strength |
| Example 13 | alternating | 8 kHz | 4 kV/mm |
| | current | | |
| Example 14 | alternating | 1 kHz | 4 kV/mm |
| | current | | |
| Example 15 | alternating | 1 kHz | 4 kV/mm |
| | current | | |
| Example 16 | alternating | 1 kHz | 2 kV/mm |
| | current | | |
| Example 17 | alternating | 0.1 kHz | 2 kV/mm |
| | current | | |

### Comparative Examples 1-4

In the same manner as in Examples 1-4 except that the electric field treatment was not performed, samples for evaluation were obtained.

### Comparative Example 5

In the same manner as in Example 5 except that the electric field treatment was not performed, a sample for evaluation was obtained.

### Comparative Example 6

In the same manner as in Example 9 except that the electric field treatment was not performed, a sample for evaluation was obtained.

### Comparative Example 7

In the same manner as in Example 13 except that the electric field treatment was not performed, a sample for evaluation was obtained.

### (Evaluation Test)

(1) Dispersibility Evaluation

SEM photographs of the mixtures obtained in Examples 2-4 and Comparative Examples 2-4 were taken using a scanning electron microscope (SEM, model S-4700, manufactured by Hitachi, Ltd.). The SEM photographs of the mixtures obtained in Examples 2-4 and Comparative Examples 2-4 are shown in FIG. 5.

From the SEM photographs, the mixtures of Examples hardly showed BaTiO₃ aggregates, but the mixtures of Comparative Examples showed many massive BaTiO₃ aggregates. This result has confirmed that, in the mixtures of the present Examples, a crush treatment and a dispersion treatment were simultaneously performed by the electric field treatment of the dispersoids in an aggregation state.

(2) Particle Size Measurement

The evaluation samples obtained in Examples 5-12 and Comparative Examples 5-6 were measured for an average particle size of dispersoids using a submicron particle analyzer (model N5, dynamic light scattering type, manufactured by Beckman Coulter, Inc.). On the presumption that CNT used in Examples 9-12 and Comparative Example 6 had a spherical shape, the average particle size was measured. The measurement results of Examples 5-8 and Comparative Example 5 are shown in Table 8, and the measurement results of Examples 9-12 and Comparative Example 6 are shown in Table 9.

TABLE 8

| | electric | | relative value |
|---|---|---|---|
| | field | average particle | when untreated |
| | frequency | size (nm) | product is 1.00 |
| Example 5 | 5 kHz | 346 | 0.87 |
| Example 6 | 1 kHz | 299 | 0.75 |
| Example 7 | 0.5 kHz | 284 | 0.71 |
| Example 8 | 0.1 kHz | 312 | 0.78 |
| Comparative | untreated | 398 | 1.00 |
| Example 5 | | | |

TABLE 9

| | electric | | relative value |
|---|---|---|---|
| | field | average particle | when untreated |
| | frequency | size (nm) | product is 1.00 |
| Example 9 | 5 kHz | 2073 | 0.33 |
| Example 10 | 1 kHz | 474 | 0.07 |
| Example 11 | 0.5 kHz | 583 | 0.09 |
| Example 12 | 0.1 kHz | 732 | 0.12 |
| Comparative | untreated | 6357 | 1.00 |
| Example 6 | | | |

The average particle size of the dispersoids in the evaluation samples obtained in Examples 13-17 and Comparative Example 7 was measured using a particle size distribution measurement apparatus (model SALD-2100, laser diffraction type, manufactured by Shimadzu Corporation). The measurement results are shown in Table 10.

TABLE 10

| | | average | relative value |
|---|---|---|---|
| | electric field | particle size | when untreated |
| | frequency | (μm) | product is 1.00 |
| Example 13 | 8 kHz | 1.01 | 0.86 |
| Example 14 | 1 kHz | 0.99 | 0.85 |
| Example 15 | 1 kHz | 1.01 | 0.87 |
| Example 16 | 1 kHz | 0.98 | 0.84 |
| Example 17 | 0.1 kHz | 0.97 | 0.83 |
| Comparative | untreated | 1.17 | 1.00 |
| Example 7 | | | |

The results of Table 10 have confirmed that the dispersibility of the dispersoids was significantly improved by applying the electric field treatment for a sufficient time of 10 min, and suppressing the frequency to 0.1-1 kHz and the electric field strength to 2-4 kV/mm.

This application is based on a patent application No. 2006-172642 filed in Japan, the contents of which are incorporated in full herein by this reference.

1. A method of uniformly dispersing dispersoids in a dispersion medium, which comprises applying an electric field to a mixture of the dispersion medium and the dispersoids.

2. A method of uniformly redispersing dispersoids in a dispersion medium, which comprises applying an electric field to a mixture of the dispersion medium and the dispersoids precipitated therein.

3. A method of crushing aggregated dispersoids, which comprises applying an electric field to a mixture of the aggregated dispersoids and the dispersion medium.

4. The method of claim 1, wherein the dispersion medium is a solvent or an organic resin, which is a liquid or has flowability at the temperature during application of the electric field.

5. The method of claim 1, wherein the dielectric constant of the dispersoid is higher than that of the dispersion medium.

6. The method of claim 1, wherein the dispersoid is at least one kind from an inorganic particle and an inorganic fiber.

7. The method of claim 1, wherein an alternating voltage is applied as the electric field.

8. The method of claim 1, wherein the electric field is applied between parallel electrodes.

9. A composition obtained by the method of claim 1.

10. The method of claim 2, wherein the dispersion medium is a solvent or an organic resin, which is a liquid or has flowability at the temperature during application of the electric field.

11. The method of claim 2, wherein the dielectric constant of the dispersoid is higher than that of the dispersion medium.

12. The method of claim 2, wherein the dispersoid is at least one kind from an inorganic particle and an inorganic fiber.

13. The method of claim 2, wherein an alternating voltage is applied as the electric field.

14. The method of claim 2, wherein the electric field is applied between parallel electrodes.

15. A composition obtained by the method of claim 2.

16. The method of claim 3, wherein the dispersion medium is a solvent or an organic resin, which is a liquid or has flowability at the temperature during application of the electric field.

17. The method of claim 3, wherein the dielectric constant of the dispersoid is higher than that of the dispersion medium.

18. The method of claim 3, wherein the dispersoid is at least one kind from an inorganic particle and an inorganic fiber.

19. The method of claim 3, wherein an alternating voltage is applied as the electric field.

20. The method of claim 3, wherein the electric field is applied between parallel electrodes.

21. A composition obtained by the method of claim 3.

22. A dispersion apparatus for dispersoids, comprising a container for placing a mixture of a dispersion medium and dispersoids, and an electric field application means having a pair of opposing electrodes, which is used for applying an electric field to the mixture.

23. An apparatus for redispersing or crushing dispersoids, comprising a container for placing a mixture of a dispersion medium and aggregated or precipitated dispersoids, and an electric field application means having a pair of opposing electrodes, which is used for applying an electric field to the mixture.

24. The apparatus of claim 22, further comprising, in the container, a stirring means for agitating the mixture.

25. The apparatus of claim 22, further comprising a feeding means for feeding the mixture to the electric field application means.

26. The apparatus of claim 22, further comprising a crude dispersion means for roughly dispersing the dispersoids in the mixture.

27. The apparatus of claim 22, wherein the waveform of a power source of the electric field is an alternating current.

28. The apparatus of claim 22, wherein the electrode comprises parallel electrodes.

29. The apparatus of claim 23, further comprising, in the container, a stirring means for agitating the mixture.

30. The apparatus of claim 23, further comprising a feeding means for feeding the mixture to the electric field application means.

31. The apparatus of claim 23, further comprising a crude dispersion means for roughly dispersing the dispersoids in the mixture.

32. The apparatus of claim 23, wherein the waveform of a power source of the electric field is an alternating current.

33. The apparatus of claim 23, wherein the electrode comprises parallel electrodes.
